(19) United States
(12) Patent Application Publication
(10) Pub. No.: US 2009/0285281 A1
(43) Pub. Date: Nov. 19, 2009

(54) ENERGY EFFICIENT DATA PROCESSING

(75) Inventor: Peter Kaarle, Furulund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/131,319

(22) Filed: Jun. 2, 2008

Related U.S. Application Data
(60) Provisional application No. 61/054,224, filed on May 19, 2008.

(51) Int. Cl. H04N 11/04; H04L 27/28; H04M 1/00

(52) U.S. Cl. 375/240.01; 375/260; 455/550.1; 375/E07.001

(57) ABSTRACT

The present invention relates to parallel treatment of DVB-H data bursts. It provides a method of reception of consecutive at least first and second data bursts and a data reception unit. The method comprise receiving a first data burst, processing the first data burst during a first period, and receiving a second data burst during a second time period, wherein the first and second time periods at least to some extent overlap in time. By using a first and a second memory for storing alternating data bursts, the data reception unit can be kept in an inactive less power consuming mode a longer time, thus saving energy as compared to prior art techniques.

### CROSS-REFERENCE TO RELATED APPLICATION

This application claims the benefit of U.S. Provisional Patent Application Ser. No. 61/054,224, filed May 19, 2008, the entire disclosure of which is hereby incorporated by reference.

### TECHNICAL FIELD

The present invention relates in general to energy efficient data processing and in particular to energy efficient data processing of OFDM data bursts.

### BACKGROUND

Recently, portable communications devices such as mobile phones, can be provided with a television (TV) option. The TV option service in the portable communication is typically the digital video broadcasting-handheld (DVB-H) solution.

The TV service is unfortunately power consuming, for which reason the battery capacity of the mobile phone comprising the TV option, decreases with increasing time of having the TV switched on.

It can be noted that DVB-H uses a form of transmission called Orthogonal Frequency Division Multiplexing (OFDM) multicarrier modulation.

In DVB-H, consecutive data bursts of a relatively high bandwidth are received over the air by the mobile device, after which the mobile phone can present continuous TV data with a lower bandwidth. The data bursts are typically received by a TV chip comprised in the mobile phone.

FIG. 1 presents one way of burst data reception according to prior art technique, where a first data burst 102 is received. This data reception takes some time that is governed by the data size and the reception bandwidth. After having received the first data burst, the data may then be multiprotocol encapsulated and forward error corrected 104. This step also takes some times as indicated by the width of box 104 along the time line in FIG. 1. Thereafter the data can be sent in step 106 to a hosting processor hosting the TV-chip. As the step of reception takes some time, this step of sending data also takes some time, as determined by the bandwidth used and the data size to be sent to the host.

As the TV-chip receives data it also consumes power, which means that the TV-chip consumes power during duration of receiving data. Moreover, the TV-chip also consumes power as it encapsulates the received data and performs the error correction during the duration corresponding to 104. In addition, sending data to the host consumes power, for which reason the chip consumes power during the time durations 102, 104 and 106. The TV-chip is thus switched on during these time durations. However, after time duration 106, the chip may be switched off, or be inactivated during a time duration 110, until a second data burst 108 is received. The chip may thus be in inactive or passive mode during time duration 110 of the total frame time 112 between two consecutive data bursts.

Since the battery capacity in mobile phones is limited, an attempt to reduce the power consumption when watching TV using the DVB-H technique is sought.

### SUMMARY

The present invention is directed towards consuming less electric power when using DVB-H service.

According to an aspect of the present invention, there is provided a method of reception of consecutive at least first and second data bursts comprising receiving a first data burst, processing the first data burst during a first period, and receiving a second data burst during a second time period, wherein the first and second time periods at least to some extent overlap.

Said step of receiving a first data burst and said step of receiving a second data burst, may each comprise receiving an orthogonal frequency division multiplexing encoded data burst.

Said processing of the first data burst may comprise performing protocol encapsulation of the first data burst.

Said processing of the first data burst may comprise performing forward error correction of the first data burst.

Said processing of the first data burst may also comprise sending encapsulated and error corrected first data burst over a data interface bus.

The first and second data bursts within the method for reception of consecutive data bursts may comprise digital video broadcasting-handheld (DVB-H) data bursts.

The first and second time periods, within the method for reception of consecutive data bursts, may overlap to such an extent that the first time period comprises the entire second time period or that the second time period comprises the entire first time period.

According to another aspect of the present invention, there is provided a data reception unit for reception of consecutive at least first and second data bursts comprising a receiver unit arranged to receive a first data burst, and a processor unit arranged to process the first data burst during a first time period, where the receiver unit further is arranged to receive a second data burst during a second time period, wherein the first and second time periods at least to some extent overlap.

The processor may be arranged to decode orthogonal frequency division multiplexing encoded first and second data bursts.

The processor may be arranged to multiprotocol encapsulate the first data burst during the first time period.

The processor may be arranged to forward error correct the first data burst during the first time period.

The processor unit may be arranged to send the first data burst over a data interface bus during the first time period.

The first and second time periods, for the data reception unit, may overlap to such an extent that the first time period comprises the entire second time period or that the second time period comprises the entire first time period.

The data bursts for the data reception unit may comprise digital video broadcasting-handheld (DVB-H) data bursts.

The processor unit may be arranged to store the first data burst in a first memory area, and the second data burst in a second memory area.

A portable communication device may comprise a data reception unit for reception of consecutive data bursts comprising a receiver unit arranged to receive a first data burst, and a processor unit arranged to process the first data burst during a first time period, where the receiver unit further is arranged to receive a second data burst during a second time period, wherein the first and second time periods at least to some extent overlap.

The portable communication device may comprise a mobile phone.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments will be described below, references being made to the accompanying drawings, in which

FIG. 1 shows a processing scheme illustrating prior art;

FIG. 2 shows a processing scheme illustrating some embodiments of the present invention;

FIG. 3 shows a processing scheme illustrating another embodiment of the present invention;

FIGS. 4 shows a data reception unit illustrating some embodiments of the present invention;

FIGS. 5A and 5B show a flowchart illustrating some embodiments of the present invention; and

FIG. 6 shows a device illustrating one embodiment of the present invention.

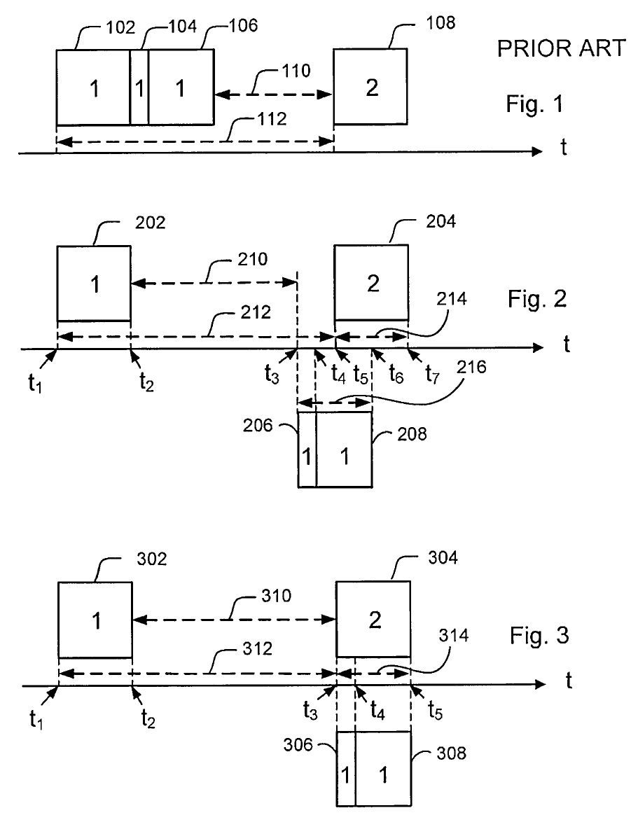

### DETAILED DESCRIPTION

With reference to FIG. 2 showing a processing scheme illustrating a general idea of some embodiments of the present invention, the present invention will now be explained.

According to this embodiment a first data burst 202 of DVB-H data is received. The data size of such a burst is typically 2 Mbit. Using a bandwidth of 10 Mbit/s, a data size of 2 Mbit can be received in 200 ms. The time duration for the first data burst 202 can thus be 200 ms. The time between time stamp t1 and time stamp t2, can thus be 200 ms.

As the data of the data burst is received the data is first digitized in a A/D converter after which it is stored in a first memory area either internal or external to the device receiving the data, typically the TV-chip.

Having received and stored the first data burst, the data may then be processed. During time duration 206, that is between time stamp t3 and time stamp t4, the data of the first data burst may be processed by multiprotocol encapsulation. In addition, the data may also be forward error corrected during the same time period. Having performed these steps, the data can be sent to an entity hosting the TV-chip during the time duration 208, that is between for instance time stamps t6 and t4.

Before the entire data set has been sent to the host, a second data burst is received during time duration 204. That is at a time stamp, here denoted t5 the second data burst starts to be received by the TV-chip. This time stamp t5 is thus prior to the time stamp t6 at which the entire data from the first data burst has been sent to the host.

At time stamp t7 the second data burst is fully received. In the same way as for the first data burst, 2 Mbit data can be received in 200 ms using a bandwidth of 10 Mbit/s. The time duration 214 in FIG. 2 may thus be 200 ms.

The duration of processing the first data burst, corresponding to durations 206 and 208, that is the duration between time stamps t3 and t6, is denoted as time duration 216 in FIG. 2.

According to the embodiments for FIG. 2, the time durations 214 and 216 overlap at least to some extent. This is made possible due to a second memory area in which the second data burst is stored as it is received, in a way similar to the reception of the first data burst.

Thanks to having two memory areas, receiving one data burst may take place at the same time as processing data from another data burst. Parallel treatment of data burst is thus enabled.

Together with the ability to process or treat data in parallel comes the possibility to treat data while consuming less power. While the chip is switched on during receiving and during processing and as well as during sending of data, the total time duration of receiving, processing and sending is shorter in the case the time durations 214 and 216 overlap at least to some extent, as compared to a non-overlapping case. Since the battery capacity is limited in portable communication devices, such as mobile phones, it is an advantage to reduce the power consumption of the DVB-H service option.

The chip may be switched off at time stamp t2, switched on at time t3, to again be switched of at time stamp t7. During a whole frame 212, the chip may thus ne switched off during the duration 210.

In FIG. 3 a processing scheme illustrating another embodiment of the present invention is presented. Similar to the embodiments of FIG. 2 a first data burst 302 is received during time stamps t1 and t2. While receiving this the data is digitized and stored in a first data memory. Thereafter the chip may be inactive during a time period 310, at which the processing of the first data burst is started as well as the reception of the second data burst is started, at time stamp t3. The second data burst may again be received during 200 ms, at which end, at time stamp t5, the processing of the first data burst, including multiprotocol encapsulation and forward error correction as well as sending the data of the first data burst to the host of the TV-chip is finished. The time duration for receiving he second data burst in a second memory, 314 now overlaps the time duration of processing and sending the data of the first data burst to such an extent that they fully overlap. The time duration of receiving the second data burst may be fully comprised in the time duration for processing and sending the data of the first data burst, alternatively the time duration for processing and sending the data of the first data burst may be fully comprised in the time duration of receiving the second data burst.

According to this embodiment the chip may be switched off at time stamp t2 and kept in an inactive or passive mode until time stamp t3 at which the reception of the second data burst is started and the processing of the data of the first data burst also is started. The chip may thus be in passive mode during time duration 310 of the entire frame or time 213 between two consecutive data bursts, which in DVB-H typically is 2 s.

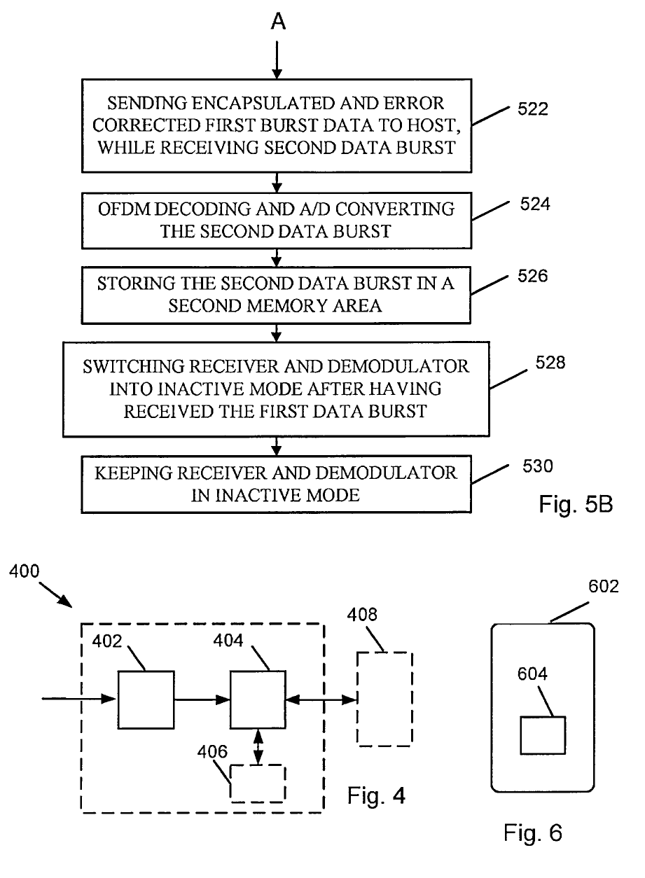

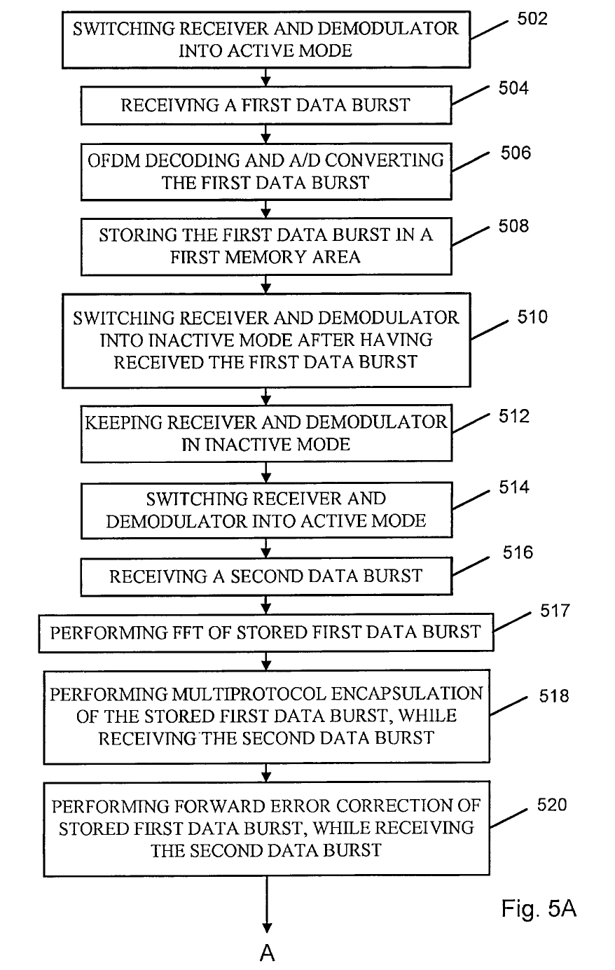

Reference is now given to FIGS. 4 and 5 presenting a data reception unit and a a flow-chart of method steps, respectively, illustrating some embodiments of the present invention.

The data reception unit 400 may be a TV-chip for reception of DVB-H data. The data reception unit 400 according to at least some embodiments comprises a data receiver 402 that is arranged to receive DVB-H data bursts. This receiver or receiving unit 402 may be connected to a processor or processing unit 404 that may be realized as a demodulator. This demodulator 404 can be connected to a memory 406 that may be comprised in the reception unit 400 or may be localized external to the reception unit 400. The demodulator 404 may also be connected to a host 408, which controls the data reception unit or TV-chip.

By providing an additional memory area to a receiving unit, for instance a TV-chip, a second data burst can be received and stored under the same time as the previously received first data burst is processed. The TV-chip can thereby utilize the time slicing of for instance DVB-H to a fuller extent by implementing a longer sleeping or inactivity mode.

Now, a flowchart illustrating at least some embodiments of method steps presented. This method may start with the step of switching the receiver or receiving unit and demodulator from passive or inactive mode into an active mode, step 502.

As mentioned above the receiver and the demodulator may be units in a data reception unit 400 or television (TV) chip, which may have an active mode and an inactive mode. The active mode consumes electric power, whereas the inactive mode consumes much less if any power.

This step of switching, step 502 may be initiated by a trigger triggering the reception of precursor data prior to the first data burst. Alternatively, a sync may synchronize time stamps and events such that the receiver and the demodulator are activated prior to the reception of the first data burst.

Having activated the receiver, the step of receiving a first data burst, step 504 is initiated. As described above in connection with FIGS. 2 and 3, reception of a DVB-H data burst may take ca. 200 ms, for which reason other steps preferably can be taken during this time duration.

While receiving the first data burst, the demodulator may start OFDM decoding and converting the data of the first data burst to digital data by A/D converting it in step 506. Having digitized the data, the data can be stored in a first data memory area in step 508.

This memory area may be comprised in the processor or the TV-chip or may be a memory that is external to the processor or the TV-chip.

Now, having stored the data of the first data burst in a first memory area, the receiver and demodulator may be switched into an inactive mode in step 510, since the function of these units may not be allocated during the next following milliseconds.

Having switched the receiver and the demodulator or at least one of them into inactive mode, the receiver and demodulator are kept in inactive mode, during the duration of step 512. The length of this inactive mode may differ among the various embodiments that can easily be visualized.

Referring to FIG. 2 it is illustrated that processing the data of the first data burst is started before starting to receive the second data burst. In FIG. 3 it is illustrated how receiving the second data starts at substantially the same time stamp as the processing of the data of the first data burst. According to a further embodiment that is not shown, the receiving of the second data burst may start prior to the processing of the data of the first data burst. With reference to the time stamps of FIG. 2, according to this further embodiment, time stamp t4 when the second data burst starts to be received is prior to the time stamp t3 when the processing of the data of the first data burst takes place. In this way time stamp t7 may also be prior to the time stamp t6, when the data of the first at burst is fully sent to the host over a secure digital input/output (SDIO) bus, being one example of a data interface bus.

It should be kept in mind that the duration of receiving and ending data is dependent on the bandwidth used for the two different steps. These bandwidths may be updated in the future and accordingly change. However according to the present DVB-H standard the bandwidth for receiving is typically 10 Mbit/s and the data rate for sending data on the SPI bus may be at least 5 Mbit/s.

It should be mentioned that a data burst of 2 Mbit comprises a data matrix with 256 columns of 1024 rows, each position having 8 bit. In total 256×1024×8 bit=2 Mbit. Of the 256 columns, only 192 columns comprise data. The remaining 64 columns comprise forward error correction (FEC) data, which is typically not sent when the error correction is performed on the chip or the data reception unit.

The amount of data to send may thus be 192×1024×8 bit=ca 1.5 Mbit.

The time required for the multiprotocol encapsulation and the forward error correction can be assumed to be 10 ms. In order to send the remaining 1.5 Mbit of data during the remaining time duration of 200 ms−10 ms=190 ms a bandwidth of 1.5 Mbit/190 ms=ca. 7.9 Mbit/s is required. This would enable the processing and the sending of the data of the first data burst during the same time interval as the receiving of the second data burst, according to the embodiment as illustrated in FIG. 3.

According to this embodiment a bandwidth of ca. 7.9 Mbit/s may thus be required for the data interface bus to finish sending data of the first data burst before the entire second data burst has been received.

As indicated above with reference to FIG. 2 the time stamp t3 may precede time stamp t5, or may be substantially at the same time as time stamp t5, see FIG. 3, or as described, may even follow time stamp t5.

In the following the method according to the flow-chart as presented in FIG. 5A and 5B, is described in accordance with the embodiment as illustrated in FIG. 3, although this is just one embodiment of many different ones that are applicable for the flow-chart.

Now, returning to the flow-chart as illustrated in FIG. 5A, after a certain time period the receiver and the demodulator may be switched into an active mode, in step 514. This step is followed by step 516, receiving a second data burst.

The processor may now perform fast Fourier transformation (FFT) of the time dependent stored first data burst, in step 517. This step is performed during the step of receiving the second data burst, in step 516.

It should again be emphasized that the step of receiving is time consuming for which reason the step of performing multiprotocol encapsulation of the stored first data burst, i.e. step 518, may be performed during the step of receiving the second data burst.

Moreover a forward error correction of the first data burst may also be performed during the receiving the second data burst, in step 520.

After having performed the multiprotocol encapsulation and the forward error correction of the first data burst, the processed data may be sent to a host. This step of sending, step 522, as illustrated together with the following steps in the flow-chart as illustrated in FIG. 5B, may also be performed during the step of receiving a second data burst.

Upon receiving the second data burst the data is converted from analogue data to digital data by an A/D converting function or a A/D converter within in step 524, after which the second data burst data is stored in a second memory area.

This memory area may as the first memory area, be comprised in a processor or the demodulator or be a memory that is external to the processor or the TV-chip.

After the step of storing the data in step 526, the receiver and the demodulator may be switched into an inactive mode in step 528. Having switched the receiver and the demodulator into inactive mode these units are kept in inactive mode during the time duration of step 530.

Although only a first and a second data bursts are presented, the described scenarios apply to multiple consecutive DVB-H data bursts that are received by the data reception unit or the TV-chip. The function of the first and second memory areas, may alternate as the new data bursts are received. While one memory area can used for receiving and storing data, the other may be used for processing and ending the data further to the host. As mentioned above this is enabled by using a two memory areas, one for each consecutive data burst. One memory area may thus be used for even numbered data bursts, and another memory area may be used for odd numbered data bursts.

In FIG. 6 a portable communication device 602 is presented, comprising a data reception unit 604, that may be arranged to further comprise a receiver unit arranged to receive a first data burst, a processor unit arranged to process the first data bust during a firs time period, where the receiver unit further is arranged to receive a second data burst during a second time period, wherein the first and second time periods at least to some extent overlap in time.

It is emphasized that the present embodiments can be varied in many ways, of which the alternative embodiments as presented are just a few examples. These different embodiments are hence non-limiting examples. The scope of the present invention, however, is only limited by the subsequently following claims.

The data interface bus that according to some embodiments comprises a secure digital input/output bus may alternatively comprise a serial peripheral interface (SPI) bus.

The data interface bus may alternatively comprise a parallel data bus for providing a connection to the host.

In addition to providing the energy efficient data processing to DVB-H, it may also be applicable to other radio access types and networks, for example to wireless local area network (W-LAN).

It should moreover be clarified that the order of steps in the flowchart of FIGS. 5A and 5B may be altered, as some steps may be comprised in other steps and some steps may further be divided into sub-steps.

According to at least some alternative embodiments, the step of performing fast Fourier transform (FFT), step 517, may be performed prior to storing the data in the memory area as a step 507 for the first data burst and as a step 525 for the second data burst.

It is also easy to understand that the embodiments come with at least one clear advantage of consuming less power when using the DVB-H service in a portable communication device.

1. A method of reception of consecutive at least first and second data bursts comprising:
receiving a first data burst,
processing the first data burst during a first period, and
receiving a second data burst during a second time period, wherein the first and second time periods at least to some extent overlap in time.

2. The method according to claim 1, wherein the step of receiving a first data burst and the step of receiving a second data burst, each comprises receiving an orthogonal frequency division multiplexing encoded data burst.

3. The method according to claim 1, wherein the step of processing the first data burst comprises performing protocol encapsulation of the first data burst.

4. The method according to claim 1, wherein the step of processing the first data burst comprises performing forward error correction of the first data burst.

5. The method according to claim 1, wherein the step of processing the first data burst comprises sending encapsulated and error corrected first data burst over a data interface bus.

6. The method according to claim 1, wherein the first and second data bursts comprise digital video broadcasting-handheld (DVB-H) data bursts.

7. The method according to claim 1, wherein the first and second time periods overlap to such an extent that the first time period comprises the entire second time period, or that the second time period comprises the entire first time period.

8. A data reception unit for reception of consecutive at least first and second data burst comprising:
a receiver unit arranged to receive a first data burst, and
a processor unit arranged to process the first data burst during a first time period,
where the receiver unit further is arranged to receive a second data burst during a second time period, wherein the first and second time periods at least to some extent overlap in time.

9. The data reception unit according to claim 8, wherein the processor is arranged to decode orthogonal frequency division multiplexing encoded first and second data bursts.

10. The data reception unit according to claim 8, wherein the processor is arranged to multiprotocol encapsulate the first data burst during the first time period.

11. The data reception unit according to claim 8, wherein the processor is arranged to forward error correct the first data burst during the first time period.

12. The data reception unit according to claim 8, wherein the processor unit is arranged to send the first data burst over a data interface bus during the first time period.

13. The data reception unit according to claim 8, wherein the first and second time periods overlap to such an extent that the first time period comprises the entire second time period, or that the second time period comprises the entire first time period.

14. The data reception unit according to claim 8, wherein the data bursts comprise digital video broadcasting-handheld (DVB-H) data bursts.

15. The data reception unit according to claim 8, wherein the processor unit is arranged to store the first data burst in a first memory area, and the second data burst in a second memory area.

16. A portable communication device comprising a data reception unit according to claim 8.

17. A portable communication device according to claim 16, wherein the portable communication device comprises a mobile phone.
